(19) United States
(12) Patent Application Publication
(10) Pub. No.: US 2020/0387169 A1
(43) Pub. Date: Dec. 10, 2020

(54) Feature Sharing in Autonomous Convoy

(71) Applicants: Alberto Daniel Lacaze, Potomac, MD (US); Karl Nicholas Murphy, Rockville, MD (US)

(72) Inventors: Alberto Daniel Lacaze, Potomac, MD (US); Karl Nicholas Murphy, Rockville, MD (US)

(73) Assignee: Alberto Daniel Lacaze, Gaithersburg, MD (US)

(21) Appl. No.: 16/430,671

(22) Filed: Jun. 4, 2019

(51) Int. Cl. G05D 1/02; G05D 1/00

(52) U.S. Cl. CPC G05D 1/0293; G05D 1/0027; G05D 1/0088; G05D 2201/0213; G05D 1/0251; G05D 1/0242; G05D 1/0248

(57) ABSTRACT

A system has been developed for sharing driving relative information among autonomous vehicles in the convoy comprising two or more autonomous vehicles in the convoy, sensors on each autonomous vehicle that can perceive road or traffic related features, a method for individually labelling features, a method for encoding characteristics of that feature to distinguish them from the other features so that another autonomous vehicle can re-locate and re-classify the same feature and a communication mechanism that allows the different autonomous vehicles to share features, labels, and feature characteristics. Obstacles that are detected are classified and they are tracked if the same obstacles continually appear. Some classification labels include vegetation, poles, vehicles, jersey barriers, etc. The same obstacles are collected with multiple autonomous vehicles. The classification labels that are collected from one convoy of autonomous vehicles is compared to classification labels obtained by another convoy of autonomous vehicles to determine the changes in the obstacles over time. Chips of the obstacles are automatically collected by the system and stored in the database.

### CROSS-REFERENCES TO RELATED APPLICATIONS

Not applicable.

### BACKGROUND OF THE INVENTION

### 1. Field of the Invention

The present invention involves the development of a system that is sued for sharing driving relative information among autonomous vehicles in the convoy comprising two or more autonomous vehicles in the convoy, sensors on each autonomous vehicle that can perceive road or traffic related features such as pedestrians, speed bumps, signs, vehicles, a method for individually labelling features, a method for encoding characteristics of that feature as to distinguish them from the other features so that another autonomous vehicle can re-locate and re-classify the same feature and a communication mechanism that allows the different vehicles to share features, labels, and feature characteristics. It also involves detecting obstacles and classifying them as well as tracking the ones that continually appear. In addition, the classification labels gathered from one convoy of autonomous vehicles will be compared to that of another convoy of autonomous vehicles to determine the changes in the obstacles over time. Chips of the obstacles are automatically collected by the system and stored in the database.

### 2. Description of Related Art

The statements in this section merely provide background information related to the present disclosure and may not constitute prior art.

There have been no reports in the patent literature of a system that tracks obstacles that continually appears and also compares the classification labels from one convoy to another to determine the changes in the obstacles over time. There are also no reports of a system that is used to share driving relative information among autonomous vehicles in the convoy comprising two or more autonomous vehicles in the convoy, sensors on each autonomous vehicle that can perceive road or traffic related features, a method for individually labeling features, a method for encoding characteristics of that feature as to distinguish them from the other features so that another autonomous vehicle can re-locate and re-classify the same feature and a communication mechanism that allows the different autonomous vehicles to share features, labels, and feature characteristics.

A system and method fir causing an autonomous vehicle to track a desired path uses reference postures to define the reference path. The actual vehicle postures are determined using sensors aboard the autonomous vehicle. An expected vehicle posture at the end of a next time interval is determined on the actual vehicle posture. A desired posture at the end of the next time interval is determined based on the reference postures. This system and method are discussed in U.S. Pat. No. 5,657,226. This patent does not involve tracking obstacles that appear continually over time and also does not track changes in obstacles over time and also does not involve a system that is used to share driving relative information among autonomous vehicles in the convoy.

There has been an arrangement for obstacle detection where tow significant data manipulations are used to provide a more accurate read of potential obstacles which contributes to a more efficient and more effective operation of an autonomous vehicle. A first data manipulation involves distinguishing between those potential obstacles that are surrounded by significant background scatter in a radar diagram and those that are not. This is discussed in US Patent Publication #20100026555A1. In this patent, there is no discussion on tracking obstacles that appear continually over time and about changes in obstacles over time or any discussions about a system that is used to share driving relative information among autonomous vehicles in the convoy.

There has been another patent which deals with a system and method for vehicle detection and tracking as can be seen in EP1606769B1. Here, this patent does not mention about tracking obstacles that appear continually or about tracking changes in obstacles over time.

There has been a system and method developed for tracking obstacles by an autonomous vehicle. Localization sensors that measure pitch, yaw, and roll and systems that have an inertial navigation system, a compass, a global positioning system, or an odometer detects the position of the vehicle. Perception sensors such as LIDAR, stereo vision, infrared vision, radar, or sonar assess the environment around the vehicle. Using these sensors, the locations of the terrain features relative to the vehicle are computed and kept up-to-date. The vehicle trajectory is adjusted to avoid terrain features that are obstacles in the path of the vehicle. This system and method is discussed in U.S. Pat. No. 7,499,775. While this patent discusses tracking obstacles of an autonomous vehicle, it does not discuss tracking changes in obstacles over time and also does not discuss a system that is used to share driving relative information among vehicles in the convoy.

Overall, there have not been any reports on tracking obstacles that continually appear on the path of the autonomous vehicles as well as tracking the changes in these obstacles over time or of a system for sharing driving relative information among vehicles in the convoy comprising two or more autonomous vehicles in the convoy, sensors on each autonomous vehicle that can perceive road or traffic related features, a method for individually labeling features, a method for encoding characteristics of that feature as to distinguish them from the other features so that another autonomous vehicle can re-locate and re-classify the same feature and a communication mechanism that allows the different autonomous vehicles to share features, labels, and feature characteristics.

### SUMMARY OF THE INVENTION

There has been a system that has been developed for sharing driving relative information among autonomous vehicles in the convoy that is composed of two or more autonomous vehicles in the convoy, sensors on each vehicle that can perceive road or traffic related features such as pedestrians, speed bumps, signs, or vehicles, a method for individually labeling features, a method for encoding characteristics of the feature as to distinguish them from the other features so that another autonomous vehicle can re-locate and reclassify the same feature and a communication mechanism that allows the different vehicles to share features, labels, and feature characteristics.

A system has been developed for classifying objects that are detected and tracking if these obstacles continually appear. In addition, the classification labels obtained from one convoy of autonomous vehicles is compared to that obtained from another convoy of autonomous vehicles to track changes in the obstacles over time.

Chips of the obstacles are automatically collected by the system and stored in the database.

### BRIEF DESCRIPTION OF THE DRAWINGS

The present invention is described in the detailed description that follows, with reference to the following noted drawings that illustrate non-limiting examples of embodiments of the present invention, and in which like reference numerals represent similar parts throughout the drawings.

FIG. 1—Illustration in which the pedestrian, (P₁), (101) is detected by autonomous vehicle 1, (V₁(100) and this is detected in the autonomous vehicle 1 sensor range (105). Autonomous vehicle 1, (V₁), (100) communicates the features of the pedestrian, (P₁), (101) to the rest of the convoy represented by autonomous vehicle 2, (V₂), (103). In this case, there is a communication mechanism (102) between the two autonomous vehicles and there is an onboard database (104) where this information is stored. The pedestrian (101) is detected by autonomous vehicle 1 (100) at the sensor range of autonomous vehicle 1 (100), while autonomous vehicle 2 (103) picks up the communications signals from autonomous vehicle 1 (100) and this occurs in the autonomous vehicle 2 sensor range (106).

FIG. 2—Illustration of detection using onboard sensors by autonomous vehicle (V₂) (200) of the pedestrian (205). There is an onboard database (201) and the pedestrian (P₁) is detected from autonomous vehicle 1 (V₁) (202) and also detected from autonomous vehicle 2, (V₂) using onboard sensors (203). In addition, the pedestrian (P₁) that is seen from autonomous vehicle (V₁) is matched with the pedestrian (P₁) seen from the autonomous vehicle (V₂). The entire process is conducted in the autonomous vehicle 2 (V₂) sensor range (204).

### DETAILED DESCRIPTION OF THE INVENTION

Elements in the Figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

Unless specifically set forth herein, the terms “a,” “an,” and “the” are not limited to one element, but instead should be read as meaning “at least one.” The terminology includes the words noted above, derivatives thereof, and words of similar import.

The particulars shown herein are given as examples and are for the purposes of illustrative discussion of the embodiments of the present invention only and are presented in the cause of providing what is believed to be the most useful and readily understood description of the principles and conceptual aspects of the present invention.

Obstacles that are detected are classified and are tracked if the same obstacles continually appear. Some classification labels include vegetation, poles, vehicles, jersey barriers, etc. The same obstacles are collected with multiple autonomous vehicles.

The classification labels that are collected from one convoy of autonomous vehicles is compared to classification labels obtained by another convoy of autonomous vehicles to determine the changes in the obstacles over time. Chips of the obstacles are automatically collected by the system and stored in the database.

A system has been developed for sharing driving relative information among vehicles in the convoy that comprises two or more autonomous vehicles in the convoy, sensors in each of the autonomous vehicles that can perceive road or traffic related features, a method for individually labeling features, a method for encoding characteristics of that feature as to distinguish them from the other features so that another autonomous vehicle can re-locate and re-classify the same feature and a communication mechanism that allows the different vehicles to share features, labels, and feature characteristics.

This system involves the detection of a wide variety of road and traffic related features by the use of different types of sensors such as LADAR, EO cameras, FLIR cameras, or multispectral cameras. LADAR is Laser Detection and Ranging System which uses light to determine the distance to an object. LADAR can also image the target at the same time while determining the distance. EO cameras are electro-optical sensors and these as well as their data processors serve as the eyes of deployed military forces. FLIR cameras are forward-looking infrared cameras, which are typically used in military and civilian aircraft, use a thermographic camera that senses infrared radiation. Multispectral cameras involve imaging data obtained specific wavelength ranges across the electromagnetic spectrum. These traffic and road related features are individually classified by the system and stored in the database of classified features. In addition, there is a mechanism that is involved for distinguishing these traffic and road related features from those of other features that are present in the road that involves encoding the characteristics of these features. This method of distinguishing the features allows other autonomous vehicles to re-classify and re-locate these features the next time they occur and especially for the same type of features that are present. The communication mechanism allows sharing of features, labels, and feature characteristics between the autonomous vehicles and this information is stored in the database of classified features in each of the autonomous vehicles.

The sensors can detect road or traffic features such as pedestrians, telephone poles, speed bumps, signs, or vehicles. The road or traffic features are not limited to these and can include a wide variety of other objects, both static and dynamic. Static features are stationary, nonmoving objects, while dynamic features are moving objects. The types of sensors that can be used ₂multispectral cameras. Other types of sensors can also be used and is not limited to these listed above.

The features that are detected by the different types of sensors are classified as being either static or dynamic. Static features are those that do not move while dynamic features are moving features. Some examples of static features are a telephone pole, speed bumps, or signs while examples of dynamic features include pedestrians and moving vehicles.

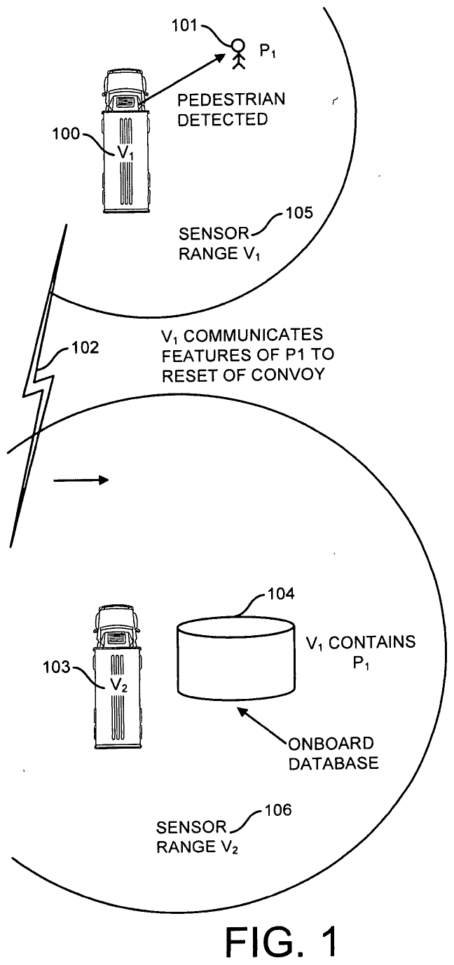

FIG. 1 illustrates when the pedestrian (101) is detected by autonomous vehicle (V₁), (100) and it communicates the features of the pedestrian to the rest of the convoy represented by autonomous vehicle 2 (103). There is a communication mechanism (102) by which the information is transferred from one autonomous vehicle (100) to another following autonomous vehicle (103). Here, there is an onboard database (104) where this information is stored in the autonomous vehicle. The pedestrian (101) is initially sensed by autonomous vehicle 1 (100) in the sensor range of autonomous vehicle 1 (105) and then the information is transferred over to autonomous vehicle 2 (103) via a communication mechanism (102) in the sensor range of autonomous vehicle 2 (106).

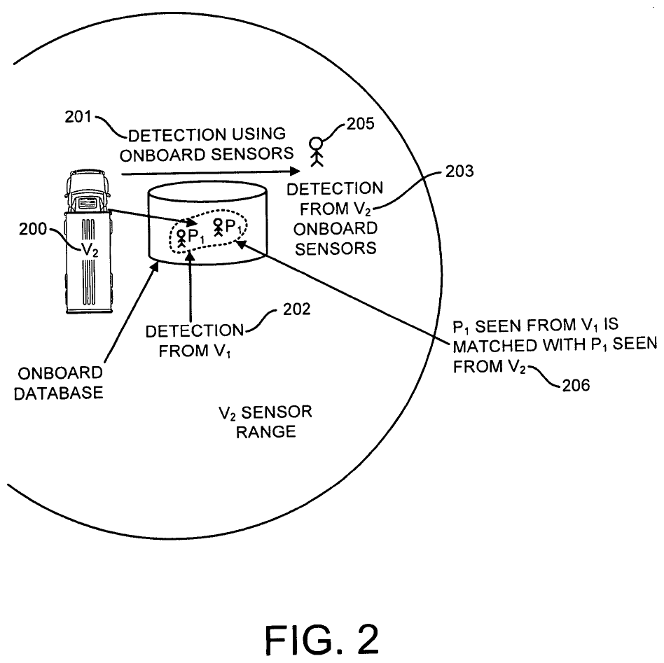

FIG. 2 illustrates a scenario when there is detection of the pedestrian (205) using onboard sensors by autonomous vehicle 2, (V₂), (200) of the pedestrian (205). There is an onboard database (201) and the pedestrian (205) is detected from autonomous vehicle, (V₁) and also detected from autonomous vehicle, (V₂), (200) using onboard sensors. In addition, the pedestrian (205) that is detected from autonomous vehicle, (V₁), is matched with the pedestrian (205) that is detected from autonomous vehicle 2, (V₂) (200) in the onboard database. The entire process takes place in the sensor range of autonomous vehicle 2 (200).

The speed, acceleration, or jerk is estimated or filtered, and the information detected from each sensor is fused in the autonomous vehicle before sending it to other autonomous vehicles. The position of the road or traffic related feature is also shared with other autonomous vehicles.

The features are accumulated for the whole convoy into a single map and the location of the features is stored as a probability density function taking under consideration the probability of the classification and the errors in prediction. A probability density function is a function of continuous random variable, whose integral across an interval gives the probability that the value of the variable lies within the same interval.

The filter uses measurements taken from multiple vehicles to estimate shape, size, speed, location, or acceleration. The features are shared among the different autonomous vehicles when the convoy of autonomous vehicles are moving forward and/or backing up. Only features that are close to the path that the convoy is taken are being shared, and other features are only shared if the bandwidth allows.

The embodiments of the invention in which an exclusive property or privilege is claimed are defined as follows:

1. A system for sharing driving relative information among autonomous vehicles in the convoy comprising:
two or more autonomous vehicles in the convoy;
sensors on each autonomous vehicle that can perceive road or traffic related features (pedestrians, speed bumps, signs, vehicles);
a method for individually labeling features;
a method for encoding characteristics of that feature as to distinguish them from the other features so that another autonomous vehicle can re-locate and re-classify the same feature and;
a communication mechanism that allows the different autonomous vehicles to share features, labels and feature characteristics.

2. The system of claim 1 wherein the sensors can detect road or traffic related features such as pedestrians, speed bumps, signs, or vehicles.

3. The system of claim 1 wherein the sensors are one or more of the following: LADAR, stereo vision, EO cameras, FLIR cameras or multispectral cameras.

4. The system of claim 1 wherein the features are also classified as static or dynamic features.

5. The system of claim 1 wherein a telephone pole, a speed bump, or a sign is a static feature.

6. The system of claim 1 wherein a pedestrian or a moving autonomous vehicle is a dynamic feature.

7. The system of claim 1 wherein the speed, acceleration, or jerk is estimated or filtered.

8. The system of claim 1 wherein the sensed information from each sensor is fused in the autonomous vehicle before sending it to other vehicles.

9. The system of claim 1 wherein the position of the feature is also shared with other autonomous vehicles.

10. The system of claim 1 wherein the features are accumulated for the whole autonomous convoy into a single map.

11. The system of claim 1 wherein the location of the features is stored as a probability density function taking under consideration the probability of the classification and the errors in prediction.

12. The system of claim 1 wherein the filter uses measurements taken from multiple autonomous vehicles to estimate shape, size, speed, location or acceleration.

13. The system of claim 1 wherein the features are shared when the autonomous vehicles are moving forwards and/or backing up.

14. The system of claim 1 wherein only features that are close to the path that the autonomous convoy is taken are being shared, and other features are only shared if the bandwidth allows.
